(19) United States
(12) Patent Application Publication
(10) Pub. No.: US 2015/0221258 A1
(43) Pub. Date: Aug. 6, 2015

(54) BACKLIGHT DRIVING CIRCUIT, DRIVING METHOD AND BACKLIGHT MODULE

(71) Applicant: Shenzhen China Star Optoelectronics Technology Co. Ltd., Shenzhen, Guangdong (CN)

(72) Inventor: Xiangyang Xu, Shenzhen City (CN)

(21) Appl. No.: 14/130,466

(22) PCT Filed: Nov. 20, 2013
(86) PCT No.: PCT/CN2013/087502

§ 371 Date: Dec. 31, 2013

(30) Foreign Application Priority Data
Nov. 15, 2013 (CN) 201310574634.3

(51) Int. Cl. G09G 3/34; G09G 5/10

(52) U.S. Cl. CPC G09G 3/3406; G09G 5/10

(57) ABSTRACT

A backlight driving circuit is disclosed. The backlight driving circuit includes a temperature sensing module, a comparing module and a backlight driving module. The temperature sensing module is for monitoring a temperature of different areas of a loading and is for outputting a plurality of sensing signals. The comparing module is for comparing the plurality of sensing signals generated from the temperature sensing module and for outputting control signals. The control signals are for controlling an amount of the driving current outputted from the backlight module. The backlight driving module is for converting an input voltage to a needed driving current and for providing the driving current to the loading. By configuring the temperature sensing module in the proximity of the backlight source, the backlight driving circuit monitors the working temperature of different areas of the backlight source and provides the working temperature to the backlight driving module.

### BACKGROUND OF THE INVENTION

1. Field of the Invention

The present disclosure relates to liquid crystal display technology, and more particularly to a backlight driving circuit, a driving method, a backlight module and a liquid crystal device.

2. Discussion of the Related Art

With the technology development, a lot of digital products are designed to satisfy consumers need. In the past, Cathode Ray Tube (CRT) is the main display device. However, the CRT is harmful to heavy users due to the radiation generated and the large amount of power consumption. Therefore, Liquid Crystal Display (LCD) is the new technology developed to replace the CRT.

LCDs are characterized by attributes such as thinner, power-saving, low radiation, and thus are widely adopted. Currently, most of the LCDs are backlight type, which includes a liquid crystal panel and a backlight module. The operating principle of the liquid crystal panel will be described hereinafter. Liquid crystal molecules are displaced between two parallel glass substrates. In addition, a driving voltage is applied to the two glass substrates to control the rotation of the liquid crystal molecules such that the light beams reflected from the backlight module are utilized to generate images. As the liquid crystal panel does not emit the light beams itself, and thus backlight module is needed to provide the light source. Therefore, the backlight module is a key component of the liquid crystal device. Generally, backlight modules are divided into edge-type and direct-type backlight modules according to the incident location of light source. Regarding direct-type backlight module, the light source, such as CCFL (Cold Cathode Fluorescent Lamp) or LED (Light Emitting Diode) is disposed behind the liquid crystal panel, which forms a surface light source for the liquid crystal panel. Regarding the edge-type backlight module, the light source is disposed on edges of the back plate, which is located behind the liquid crystal panel. The light beams emitted from the light source, i.e., the LED, enter the LGP (light guiding plate) via the incident surface, and then are emitted outward via the light emitting surface after being reflected and being diffused. Afterward, the light beams pass through an optical film set to form the surface light source for the liquid crystal panel.

The backlight driving circuit of the backlight module drives the LED to emit light beams so as to provide the backlight source. When being driven by the backlight driving circuit, the LED converts a portion of the energy to the light beams, also, a portion of the energy is converted to heat. Thus, the heat generated by the LED is related to the number of the LED. The larger the driving current is, the more heat is generated by the LED. However, working in a high temperature for a long time, not only the life cycle of the LED is decreased, but also the color range of the LED is affected. As such, the color performance of the liquid crystal device is affected also. Especially for those large-scale liquid crystal devices, higher backlight brightness is needed. As the driving voltage of single LED is low, which results in a limited lighting performance, generally, a plurality of LEDs that are serially connected or connected in parallel are adopted in the backlight module to be the light source. To further enhance the backlight brightness, methods for increasing the driving current of the LED are also adopted. As a result, more heat is generated by the LED, and the higher working temperature may affect the performance of the LED components. At the same, while a large number of LEDs that are serially connected or connected in parallel are adopted, the lighting performance of the LEDs located in the area with higher temperature may be affected such that the brightness and the chromaticity of the liquid crystal device is not uniformly distributed.

### SUMMARY

In one aspect, a backlight driving circuit includes: a temperature sensing module for monitoring a temperature of different areas of a loading and for outputting a plurality of sensing signals; a comparing module for comparing the plurality of sensing signals generated from the temperature sensing module and for outputting control signals, and the control signals are for controlling an amount of the driving current outputted from the backlight module; and a backlight driving module for converting an input voltage to a needed driving current and for providing the driving current to the loading.

Wherein the control signals generated by the comparing module is the largest sensing signals among the sensing signals generated by the temperature sensing module.

Wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

Wherein one end of the temperature sensor connects to a reference voltage, and the other end of the temperature sensor couples with the comparing module.

Wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

Wherein one end of the temperature sensor connects to a reference voltage, and the other end of the temperature sensor couples with the comparing module.

In another aspect, a backlight driving method includes: A) Providing a temperature sensing module, a comparing module, and a backlight driving module; B) Monitoring a working temperature for different areas within a loading by the temperature sensing module and generating a plurality of sensing signals; C) Comparing the plurality of sensing signals by the comparing module and generating control signals for controlling an amount of the driving current outputted by the backlight driving module.

Wherein the comparing step C) further comprises: selecting the largest sensing signals to be the control signals by the comparing module; providing one reference signal; and generating a first adjustment signal by the backlight driving module when the control signal is larger than the reference signal, and generating a second adjustment signal for retaining the amount of the driving current when the control signal is smaller than the reference signal.

Wherein the comparing step C) further comprises: providing a reference signal and comparing the plurality of sensing signals with the reference signal; and generating a first control signal by the comparing module for controlling the backlight driving module to decrease the driving current when at least one sensing signal is larger than the reference signal, and generating a second control signal for controlling the backlight driving module to retain the amount of the driving current when all of the sensing signals are smaller than the reference signal.

In another aspect, a backlight module includes: a backlight driving circuit comprises:

a temperature sensing module for monitoring a temperature of different areas of a loading and for outputting a plurality of sensing signals; a comparing module for comparing the plurality of sensing signals generated from the temperature sensing module and for outputting control signals, and the control signals are for controlling an amount of the driving current outputted from the backlight module; and a backlight driving module for converting an input voltage to a needed driving current and for providing the driving current to the loading.

Wherein the control signals generated by the comparing module is the largest sensing signals among the sensing signals generated by the temperature sensing module.

Wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

Wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

Wherein one end of the temperature sensor connects to a reference voltage, and the other end of the temperature sensor couples with the comparing module.

In another aspect, a liquid crystal device includes: a backlight module comprising a backlight driving circuit and a liquid crystal panel, the backlight driving circuit comprises: a temperature sensing module for monitoring a temperature of different areas of a loading and for outputting a plurality of sensing signals; a comparing module for comparing the plurality of sensing signals generated from the temperature sensing module and for outputting control signals, and the control signals are for controlling an amount of the driving current outputted from the backlight module; and a backlight driving module for converting an input voltage to a needed driving current and for providing the driving current to the loading.

Wherein the control signals generated by the comparing module is the largest sensing signals among the sensing signals generated by the temperature sensing module.

Wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

Wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

Wherein one end of the temperature sensor connects to a reference voltage, and the other end of the temperature sensor couples with the comparing module.

### BRIEF DESCRIPTION OF THE DRAWINGS

FIG. 1 is a schematic view showing the operation principle of the backlight driving circuit in accordance with a first embodiment.

FIG. 2 is a circuit diagram of the backlight driving circuit of FIG. 1.

FIG. 3 is a schematic view showing the loading structure of FIG. 1.

FIG. 4 is a schematic view showing the operation principle of the backlight driving circuit in accordance with a second embodiment.

FIG. 5 is a schematic view showing the structure of the backlight module in accordance with one embodiment.

FIG. 6 is a schematic view showing the structure of the liquid crystal panel of the liquid crystal device in accordance with one embodiment.

### DETAILED DESCRIPTION OF THE EMBODIMENTS

Embodiments of the invention will now be described more fully hereinafter with reference to the accompanying drawings, in which embodiments of the invention are shown.

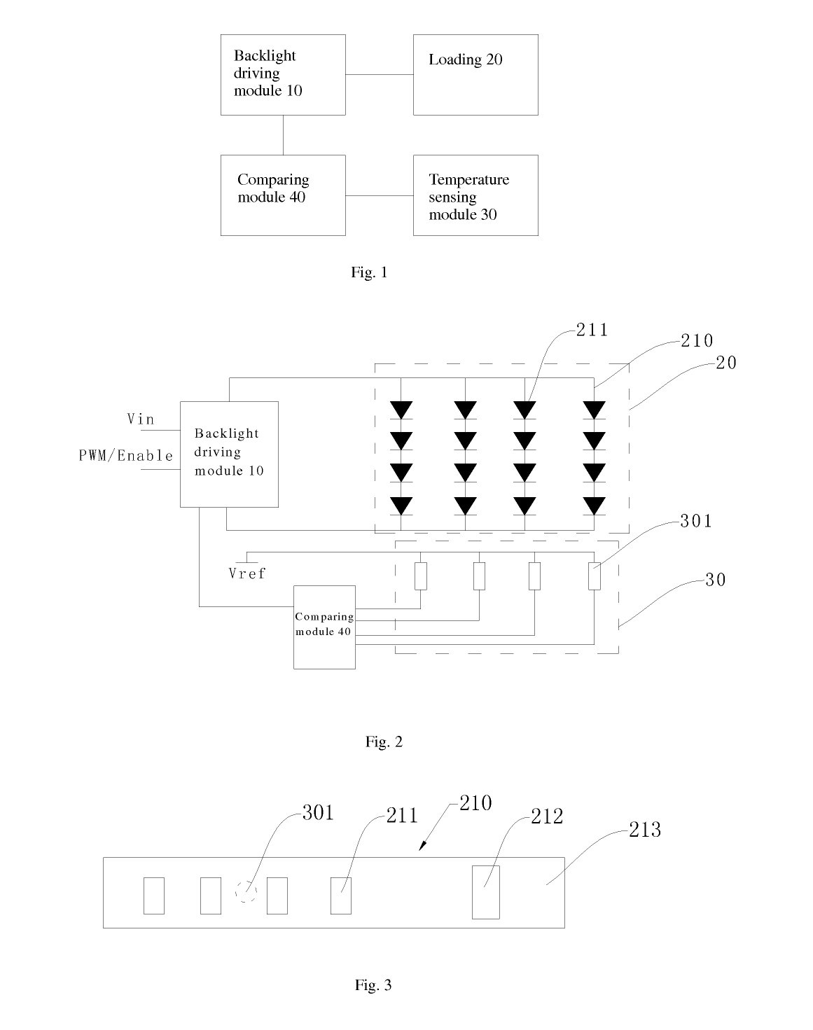

FIG. 1 is a schematic view showing the operation principle of the backlight driving circuit in accordance with a first embodiment. The backlight driving circuit includes a temperature sensing module 30, a loading 20, a comparing module 40, and a backlight driving module 10. The temperature sensing module 30 monitors a temperature of different areas of the loading 20 and outputs a plurality of sensing signals to the comparing module 40. The comparing module 40 compares the plurality of sensing signals inputted from the temperature sensing module 30 and outputs control signals to the backlight driving module 10. The control signals are for controlling the amount of the driving current outputted from the backlight driving module 10. The backlight driving module 10 converts an input voltage to a needed driving current and then provides the driving current to the loading 20.

The control signal generated by the comparing module 40 is the largest sensing signals among the sensing signals generated by the temperature sensing module. A reference signal is configured within the backlight driving module 10. When the control signal is larger than the reference signal, the backlight driving module 10 generates a first adjustment signal to decrease the driving current. When the control signal is smaller than the reference signal, the backlight driving module 10 generates a second adjustment signal to retain the amount of the driving current.

Referring to FIGS. 2 and 3, the loading 20 includes at least one LED string 210 having a plurality of LEDs 211 serially connected. In the embodiment, the loading 20 includes four LED strings 210 connected in parallel, and each of the LED string 210 includes four serially connected LEDs 211. For the LED string 210, the LED is disposed in a positive side of a heat dissipating substrate 213, and an upper surface of the heat dissipating substrate 213 further includes a connecting electrode 212. At least one temperature sensor 301 is arranged on a down surface of the heat dissipating substrate 213, and is arranged in a location between two LEDs. The temperature sensors 301 arranged on the loading 20 are assembled to be the temperature sensing module 30. The number and the location of the temperature sensor 301 are configured in accordance with the number of the LED within the loading 20 and the configuration of the LEDs as long as a highest working temperature of the loading 20 can be detected. One end of the temperature sensor 301 connects to one reference voltage (Vref), and the other end of the temperature sensor 301 couples with the comparing module. The temperature sensor 301 generates different sensing signals in response to different working temperature. In the embodiment, the higher working temperature of the temperature sensor 301, the larger the sensing signals.

A comparator is configured within the comparing module 40 for selecting the sensing signals generated by the temperature sensor 301 located in the area with highest working temperature within the loading 20. In the embodiment, the control signals generated by the comparing module 40 is the largest sensing signals among the sensing signals generated by the temperature sensing module 30.

The backlight driving module 10 includes one Vin pin and one PWM/Enable pin. The Vin pin connects an external power source. The backlight driving module 10 converts the voltage inputted from the external power source to the driving current needed by the loading 20. The PWM/Enable pin is for manually adjusting the amount of the driving current so as to adjust the brightness of the liquid crystal device. At the same time, the PWM/Enable pin also operates as a switch for manually activating the over-heat protection function. That is, when the over-heat protection function is turn off by the PWM/Enable pin, the amount of the driving current outputted by the backlight driving module 10 is not changed by the control signals generated by the comparing module 40. When the over-heat protection function is turn on by the PWM/Enable pin, the amount of the driving current outputted by the backlight driving module 10 is changed by the control signals generated by the comparing module 40

In view of the above, a backlight driving method is also disclosed in one embodiment. The backlight driving method includes the following steps. In step A, the temperature sensing module 30, the comparing module 40, and the backlight driving module 10 are provided. In step B, the temperature sensing module 30 monitors the working temperatures for the areas within the loading 20, and generates a plurality of sensing signals. In step C, the sensing signals are compared by the comparing module 40 so as to generate the control signals for controlling the amount of the driving current outputted by the backlight driving module 10.

In step C, the comparing module 40 selects the largest control signal among the plurality of sensing signals. The backlight driving module 10 provides one reference signals. When the control signal is larger than the reference signal, the backlight driving module 10 generates the first adjustment signal to decrease the driving current. When the control signal is smaller than the reference signal, the backlight driving module 10 generates the second adjustment signal for retaining the amount of the driving current.

The backlight driving circuit is capable of adjusting the driving current of the loading 20 in accordance with the working temperature of the loading 20 so as to protect the loading 20. In this way, the life cycle of the loading 20 is prolonged and the display performance of the liquid crystal device is enhanced.

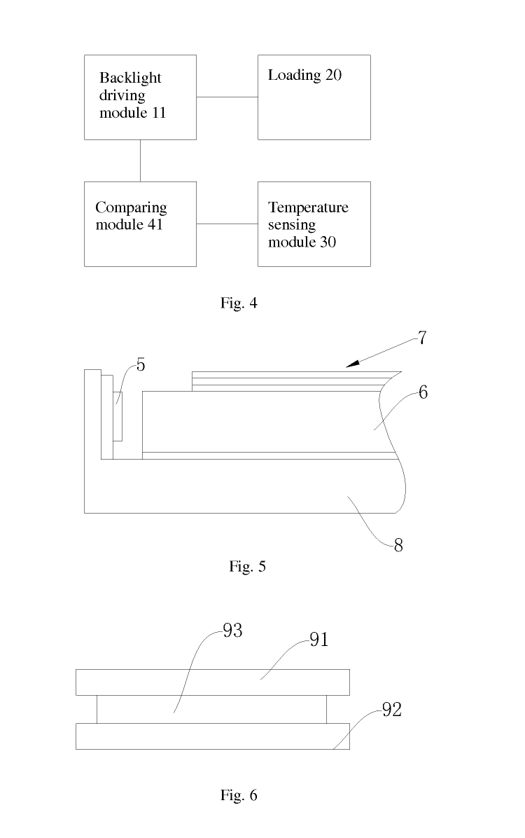

In the second embodiment, as shown in FIG. 4, the backlight driving circuit includes a temperature sensing module 30, a comparing module 41, and the backlight driving module 11. The temperature sensing module 30 monitors a temperature of different areas of the loading 20 and outputs a plurality of sensing signals to the comparing module 41. The comparing module 41 compares the plurality of sensing signals inputted from the temperature sensing module 30 and outputs the control signals to the backlight driving module 11. The control signals are for controlling the amount of the driving current outputted from the backlight driving module 11. The backlight driving module 11 converts the input voltage to a needed driving current and then provides the driving current to the loading 20.

Comparing to the first embodiment, one reference signal is configured within the comparing module 41 for comparing with the plurality of sensing signals generated by the temperature sensing module 30. When at least one of the sensing signals is larger than the reference signal, the comparing module generates a first control signal to control the backlight driving module 11 to decrease the driving current. When all of the sensing signals are smaller than the reference signal, the comparing module 41 generates a second control signal to control the backlight driving module 11 to retain the amount of the driving current.

In view of the above, a backlight driving method is also disclosed in one embodiment. The backlight driving method includes the following steps. In step A, the temperature sensing module 30, the comparing module 41, and the backlight driving module 11 are provided. In step B, the temperature sensing module 30 monitors the working temperatures for different areas within the loading 20, and generates a plurality of sensing signals. In step C, the sensing signals are compared by the comparing module 41 so as to generate the control signals for controlling the amount of the driving current outputted by the backlight driving module 11. When any one of the sensing signals is larger than the reference signal, the comparing module generates a first control signal to control the backlight driving module 11 to decrease the driving current. When all of the sensing signals are smaller than the reference signal, the comparing module 41 generates a second control signal to control the backlight driving module 11 to retain the amount of the driving current.

The backlight driving circuit is capable of adjusting the driving current of the loading 20 in accordance with the working temperature of the loading 20 so as to protect the loading 20. In this way, the life cycle of the loading 20 is prolonged and the display performance of the liquid crystal device is enhanced. In addition, the structure of the backlight driving circuit is easier and thus can be easily implemented.

In one embodiment, the backlight driving circuit and the driving method are for driving the liquid crystal device. FIG. 5 is a schematic view showing the backlight module of the liquid crystal device in accordance with one embodiment. The backlight module includes a backlight source 5, a light guiding plate 6, an optical film set 7, and a back plate 8. The backlight source 5 is fixed on the back plate 8. The backlight source 5 is driven by the above-mentioned backlight driving circuit and the driving method for providing the light source for the backlight module. The backlight source 5 adopts the LED string to be the backlight source. Comparing to other light sources, the spectrum of the LED includes ultraviolet rays and infrared rays, which do not generate radiation and pollution. In addition, the LED also owns the advantages, such as low power consumption, long life cycle, and a huge range of color restore. The light guiding plate 6 includes a light incident surface and a light emitting surface. The light incident surface faces toward the backlight source 5 for transmitting the light beams from the backlight source 5 such that the light beams emit out from the light emitting surface. The optical film set 7 is arranged above the light guiding plate 6, and the optical film set 7 faces toward the light emitting surface of the light guiding plate 6 for receiving the light beams transmitted by the light guiding plate 6. The optical film set 7 includes a plurality of optical films, such as diffusion plates or prisms. In this way, the light beams emitted from the light emitting surface of the light guiding plate 6 are uniformly diffused due to the optical film set so as to enhance the brightness of the light beams.

In one embodiment, the liquid crystal device includes the above-mentioned backlight module and the liquid crystal panel arranged above the backlight module. Referring to FIG. 6, the liquid crystal panel includes a color filter substrate 91, a thin film transistor (TFT) array substrate 92, and a liquid crystal layer 93 arranged between the color filter substrate 91 and the TFT array substrate 92. The liquid crystal layer 93 includes a plurality of liquid crystal molecules. The color filter substrate 91 arranged opposite to the TFT array substrate 92 is also called as the color filter (CF) substrate. The color filter substrate 91 usually includes a transparent substrate, such as a glass substrate, and a black matrix pattern, a color photoresist layer (such as red (R), green (G), and blue (B) filter patterns) and an alignment layer arranged above the transparent substrate. As the color filter substrate 91 is similar to the conventional color filter substrate adopted in liquid crystal devices, the concrete structure of the color filter substrate 91 may be referenced by the conventional ones. The TFT array substrate 92, which is also called as TFT substrate, usually includes the transparent substrate (such as the glass substrate) and a plurality of TFTs arranged above the transparent substrate in a matrix form. The main function of the TFT array substrate 92 relates to providing the driving voltage to the liquid crystal molecules within the liquid crystal layer 93 such that the liquid crystal molecule changes its alignment, and thus the light beams are capable of passing through the liquid crystal layer 93. In this way, the TFT array substrate 92 cooperatively operates with the color filter substrate 91 such that the liquid crystal device is capable of displaying the images.

In view of the above, by configuring the temperature sensing module in the proximity of the backlight source, the backlight driving circuit is capable of monitoring the working temperature of different areas of the backlight source and providing the working temperature to the backlight driving module. The backlight driving module adjusts the amount of the driving current according to the working temperature of the backlight source so as to prevent the backlight source from being overheated. As such, the life cycle of the backlight source is extended, and the display performance of the liquid crystal device is enhanced.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight driving circuit, comprising:
a temperature sensing module for monitoring a temperature of different areas of a loading and for outputting a plurality of sensing signals;
a comparing module for comparing the plurality of sensing signals generated from the temperature sensing module and for outputting control signals, and the control signals are for controlling an amount of the driving current outputted from the backlight module; and
a backlight driving module for converting an input voltage to a needed driving current and for providing the driving current to the loading.

2. The backlight driving circuit as claimed in claim 1, wherein the control signals generated by the comparing module is the largest sensing signals among the sensing signals generated by the temperature sensing module.

3. The backlight driving circuit as claimed in claim 2, wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

4. For any backlight driving circuit as claimed in claim 2, wherein one end of the temperature sensor connects to a reference voltage, and the other end of the temperature sensor couples with the comparing module.

5. The backlight driving circuit as claimed in claim 1, wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

6. For any backlight driving circuit as claimed in claim 1, wherein one end of the temperature sensor connects to a reference voltage, and the other end of the temperature sensor couples with the comparing module.

7. A backlight driving method, comprising:
A) Providing a temperature sensing module, a comparing module, and a backlight driving module;
B) Monitoring a working temperature for different areas within a loading by the temperature sensing module and generating a plurality of sensing signals;
C) Comparing the plurality of sensing signals by the comparing module and generating control signals for controlling an amount of the driving current outputted by the backlight driving module.

8. The backlight driving method as claimed in claim 7, wherein the comparing step C) further comprises:
selecting the largest sensing signals to be the control signals by the comparing module;
providing one reference signal; and
generating a first adjustment signal by the backlight driving module when the control signal is larger than the reference signal, and generating a second adjustment signal for retaining the amount of the driving current when the control signal is smaller than the reference signal.

9. The driving method as claimed in claim 7, wherein the comparing step C) further comprises:
providing a reference signal and comparing the plurality of sensing signals with the reference signal; and
generating a first control signal by the comparing module for controlling the backlight driving module to decrease the driving current when at least one sensing signal is larger than the reference signal, and generating a second control signal for controlling the backlight driving module to retain the amount of the driving current when all of the sensing signals are smaller than the reference signal.

10. A backlight module, comprising:
a backlight driving circuit comprises:
a temperature sensing module for monitoring a temperature of different areas of a loading and for outputting a plurality of sensing signals;
a comparing module for comparing the plurality of sensing signals generated from the temperature sensing module and for outputting control signals, and the control signals are for controlling an amount of the driving current outputted from the backlight module; and
a backlight driving module for converting an input voltage to a needed driving current and for providing the driving current to the loading.

11. The backlight module as claimed in claim 10, wherein the control signals generated by the comparing module is the largest sensing signals among the sensing signals generated by the temperature sensing module.

12. The backlight driving circuit as claimed in claim 11, wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

13. The backlight driving circuit as claimed in claim 10, wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

14. The backlight driving circuit as claimed in claim 10, wherein one end of the temperature sensor connects to a reference voltage, and the other end of the temperature sensor couples with the comparing module.

15. A liquid crystal device, comprising:
a backlight module comprising a backlight driving circuit and a liquid crystal panel, the backlight driving circuit comprises:
a temperature sensing module for monitoring a temperature of different areas of a loading and for outputting a plurality of sensing signals;
a comparing module for comparing the plurality of sensing signals generated from the temperature sensing module and for outputting control signals, and the control signals are for controlling an amount of the driving current outputted from the backlight module; and
a backlight driving module for converting an input voltage to a needed driving current and for providing the driving current to the loading.

16. The backlight module as claimed in claim 15, wherein the control signals generated by the comparing module is the largest sensing signals among the sensing signals generated by the temperature sensing module.

17. The backlight driving circuit as claimed in claim 16, wherein a reference signal is configured within the backlight driving module, when the control signal is larger than the reference signal, the backlight driving module generates a first adjustment signal to decrease the driving current, and when the control signal is smaller than the reference signal, the backlight driving module generates a second adjustment signal to retain the amount of the driving current.

18. The backlight driving circuit as claimed in claim 15, wherein a reference signal is configured within the comparing module, when at least one of the sensing signals is larger than the reference signal, the comparing module generates a first control signal to control the backlight driving module to decrease the driving current, and when all of the sensing signals are smaller than the reference signal, the comparing module generates a second control signal to control the backlight driving module to retain the amount of the driving current.

19. The backlight driving circuit as claimed in claim 15, wherein one end of the temperature sensor connects to a reference voltage, and the other end of the temperature sensor couples with the comparing module.
